(19) United States
(12) Patent Application Publication
(10) Pub. No.: US 2006/0163378 A1
(43) Pub. Date: Jul. 27, 2006

(54) Device for attenuating the stroke of the needle in pressure-controlled fuel injectors

(76) Inventor: Hans-Christoph Magel, Pfullingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/512,688

(22) PCT Filed: Apr. 3, 2003
(86) PCT No.: PCT/DE03/01101

§ 371 Date: Oct. 27, 2004

(30) Foreign Application Priority Data
Jun. 29, 2002 (DE) 102 29 415.1

(51) Int. Cl. F02M 47/02; F02M 63/00; F02M 51/00; F02M 59/00

(52) U.S. Cl. 239/88; 239/89; 239/533.2; 239/585.5

(57) ABSTRACT

The invention relates to a device for injecting fuel into a combustion chamber of an internal combustion engine, and which includes a fuel injector which can be acted upon by fuel at high pressure via a high-pressure source and is actuatable via a metering valve. Associated with the injection valve member is a damping element, which is movable independently of it and defines a damping chamber. The damping element has at least one overflow conduit for connecting the damping chamber to a further hydraulic chamber.

### CROSS-REFERENCE TO RELATED APPLICATIONS

This application is a 35 USC 371 application of PCT/DE 03/01101 filed on Apr. 3, 2003.

### BACKGROUND OF THE INVENTION

### Description of the Prior Art

For reasons of strength, the feasible pressure level in common rail injection systems in use today is limited to about 1600 bar. To increase the pressure further in common rail injection systems, pressure boosters are.

European Patent Disclosure EP 0 562 046 B 1 discloses an actuation and valve assembly with damping for an electronically controlled injection unit. The actuation and valve assembly for a hydraulic unit has an electrically excitable electromagnet, with a fixed stator and a movable armature. The armature has a first and a second surface which define a first and second hollow chamber, and the first surface of the armature points toward the stator. A valve is connected to the armature is capable of carrying a hydraulic actuation fluid from a sump to the injection device. Relative to one of the hollow chambers in the electromagnet assembly, a damping fluid can be collected there or drained off again from there. By means of a valve region that points into a central bore, the fluidic communication of the damping fluid can be selectively opened and closed in proportion to the viscosity of the fluid.

German Patent Disclosure DE 101 23 910.6 relates to a fuel injection device used in an internal combustion engine. The combustion chambers of the engine are supplied with fuel via fuel injectors which are acted upon via a high-pressure source; moreover, the fuel injection device of DE 101 23 910.6 has a pressure booster that has a movable pressure booster piston which divides a chamber, which can be connected to the high-pressure source, from a high-pressure chamber that communicates with the fuel injector. The fuel pressure in the high-pressure chamber can be varied by filling a back chamber of the pressure booster with fuel and emptying this back chamber of fuel. Page 3, please replace paragraph [0009] with the following amended paragraph:

In pressure-controlled common rail injection systems with a pressure booster, the problem arises that the stability of injection quantities to be injected into the combustion chamber, and especially the realization representation of very small preinjection quantities, which are required in a preinjection, is not reliably assured. This can be ascribed above all to the fact that the nozzle needle opens very fast in pressure-controlled injection systems. Therefore even very slight deviations in the triggering duration of the control valve can have a major effect on the injection quantity.

### SUMMARY OF THE INVENTION

### BRIEF DESCRIPTION OF THE DRAWINGS

The invention is described in further detail below in conjunction with the drawings, in which:

FIG. 1 is a schematic sectional view of a first variant embodiment of a device for stroke damping in an injection valve member with a filling path, embodied in the damping element, of a damping chamber; and

FIG. 2, a further embodiment of a device for stroke damping of an injection valve member, having a damping element which includes two filling paths for filling a hydraulic damping chamber.

### DESCRIPTION OF THE PREFERRED EMBODIMENTS

The compression chamber 15 of the pressure booster 5, which can be subjected to pressure via the second partial piston 14, communicates via a connecting line 21 with a nozzle chamber 22 embodied in the nozzle body 4 of the fuel injector 1. The nozzle chamber 22 surrounds the injection valve member 34, preferably embodied as a nozzle needle, in the region of a pressure shoulder 37 embodied on the outer circumference of the injection valve member 34. From the nozzle chamber 22, an annular gap 38 extends in the direction of the tip 39 of the injection valve member. The fuel, which is at very high pressure, in the nozzle chamber 22 flows along this annular gap 38 to the seat 40 at the combustion chamber of the injection valve member 34. Injection openings 41 that discharge into the combustion chamber 7 of a self-igniting internal combustion engine are embodied below the seat 40 of the injection valve member at the combustion chamber. The injection openings 41 are preferably embodied as concentric circles of holes, so that fine atomization of the fuel introduced into the combustion chamber 7 is assured.

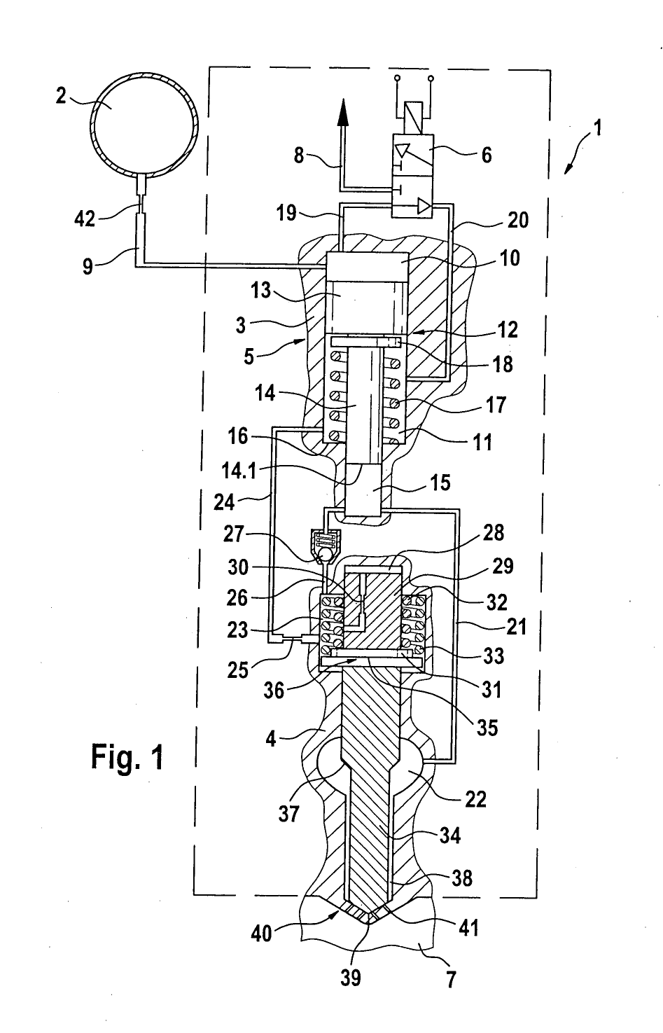

In the state of repose of the fuel injection system shown in FIG. 1, the metering valve 6 is not triggered, and no injection takes place on the end toward the combustion chamber of the injection valve member 34 into the combustion chamber 7 of the self-igniting internal combustion engine. The pressure prevailing in the interior of the high-pressure reservoir 2 (common rail) also prevails via the supply line 9 in the work chamber 10 of the pressure booster 5. Moreover, the pressure prevailing in the work chamber 10 prevails via the supply line 19 in the metering valve 6 and by way of it, via the control line 20, in the control chamber 11 of the pressure booster 5 as well. Furthermore, the pressure prevailing in the control chamber 11 of the pressure booster 5, which is equivalent to the pressure prevailing in the interior of the high-pressure reservoir 2 (common rail), also prevails via the overflow line 24 in the further hydraulic chamber 23 inside nozzle body 4. Via the filling path 26 with the check valve 27 contained in it, the rail pressure, that is, the pressure prevailing in the interior of the high-pressure reservoir 2, also prevails in the compression chamber 15 of the pressure booster 5 and, via the connecting line 21, also in the nozzle chamber 22 that surrounds the injection valve member 34. The pressure prevailing in the interior of the further hydraulic chamber 23 also prevails, via a overflow conduit 30 that includes a throttle restriction, in the damping chamber 28 that is defined by one face end of the damping element 29. Page 9, please replace paragraph [0032] with the following amended paragraph:

Accordingly, in the basic state, all the chambers 10, 11 and 15 that can be acted upon hydraulically in the pressure booster 5 are acted upon by rail pressure, that is, by the pressure level prevailing in the interior of the high-pressure reservoir 2, and the piston unit 12 inside the pressure booster 5 is in its pressure-balanced state. In this state, the pressure booster 5 is deactivated, and no pressure boosting takes place. Also in this state, the piston unit 12 of the pressure booster 5 is kept in the outset position via a restoring spring element 17. The compression chamber 15 is filled with a fuel volume from the further hydraulic chamber 23 via the filling line 26 branching off from it and having an integrated check valve 27. By means of the pressure prevailing in the further hydraulic chamber 23, a hydraulic closing force is exerted on the injection valve member 34. The hydraulic force acting on the injection valve member 34 and engaging its face end 35 can be reinforced by the spring force of the second spring element 33. Therefore the pressure prevailing in the interior of the high- pressure reservoir 2, or in other words the rail pressure, can always prevail in the pressure chamber 22 (nozzle chamber) surrounding the injection valve member 34, without causing the injection valve member 34 to open the injection openings 41 to the combustion chamber 7 of the self-igniting internal combustion engine unintentionally.

Because of the increasing hydraulic force that engages the pressure shoulder 37 of the injection valve member 34 in the pressure chamber 22, the injection valve member 34 opens in pressure-controlled fashion and uncovers the injection openings 41 at the tip 39, toward the combustion chamber, of the injection valve member 34. In the opening stroke motion of the injection valve member 34, its face end 35, which rests along the abutting seam 36 on the annular face 31 of the damping element 29, presses the injection valve member upward, so that its face end remote from the face end 35 of the injection valve member 34 moves into the damping chamber 28. The fuel volume contained in the damping chamber 28 flows, via the overflow conduit 30 that includes a throttle restriction, into the further hydraulic chamber 23 and is accordingly positively displaced into the further hydraulic chamber 23 via the overflow line 30. Because of this positive displacement, a damping force that counteracts an excessively rapid upward motion of the injection valve member 34 ensues. This causes a slowdown in the opening speed of the injection valve member 34. The needle opening speed can be varied by way of the design or in other words the flow cross section of the throttle restriction that is included in the overflow line 30.

As long as the control chamber 11 of the pressure booster 5 remains pressure-relieved and the pressure booster 5 is activated, the fuel in the compression chamber 15 of the pressure booster is compressed. The fuel, compressed in the compression chamber 15 by the movement of the second partial piston 14 inward with its face end 14.1 in the compression chamber 15, flows via the connecting line 21 into the pressure chamber 22 in the nozzle body 4 and from there along the annular gap 38 in the direction of the opened injection openings 41 and atomizes in the combustion chamber 7 of the self-igniting internal combustion engine.

For terminating the injection, upon renewed activation of the metering valve 6 in its switching position shown in FIG. 1, the control chamber 11 of the pressure booster 5 is disconnected from the return 8 on the low-pressure side again and is made to communicate with the supply line 19 to the metering valve 6, as a result of which the control chamber 11 of the pressure booster 5 is again acted upon by the pressure level prevailing in the high- pressure reservoir 2 (common rail). As a result, both in the control chamber 11 and in the further hydraulic chamber 23, the pressure level prevailing in the interior of the high-pressure reservoir 2 builds up. The second partial piston 14, which has moved with its face end 14.1 into the compression chamber 15 of the pressure booster 5, is pressure-balanced as a result of the subjection of the control chamber 11 to pressure, and as a result the pressure in the compression chamber 15 and hence in the pressure chamber 22 decreases. Since because of the communication of the control chamber 11 with the further hydraulic chamber 23 via the overflow line 24, the pressure level prevailing in the interior of the high-pressure reservoir 2 also prevails in the further hydraulic chamber 23, the injection valve member 34 is now hydraulically balanced and is closed by the spring, disposed in the further hydraulic chamber 23 and acting on the face end 35 of the injection valve member 34, and is pressed into the seat 40 at the combustion chamber. As a result, the injection of fuel into the combustion chamber 7 of the engine via the injection openings 41 is terminated. Given an appropriate hydraulic design, it is also possible to dispense with the spring that acts on the face end 35 of the injection valve member 34, or in other words the second spring element 33, since in that case, a hydraulic closing force can be generated during the closure of the injection valve member 34, or in other words during its movement inward into the seat 40 at the combustion chamber.

The injection valve member 35 can disconnect itself from the annular face 31 of the damping element 29 as it moves into the seat 40 at the combustion chamber, or in other words upon closure. This assures a fast and damped closure of the injection valve member 34 into its position that closes the injection openings 41 to the combustion chamber 7. To reduce the closing speed of the injection valve member 35, a throttle restriction 25 may be provided in the overflow line 24 between the control chamber 11 of the pressure booster and the further hydraulic chamber 23. After the pressure equalization of the system, the piston unit 12 of the pressure booster is returned to its outset position by the restoring spring 17, whereupon filling of the compression chamber 15 can take place via the further hydraulic chamber 23, by means of the aforementioned filling path 26 with the integrated check valve 27. The damping element 29, preferably embodied as a damping piston, is restored to its outset position by the first spring element 32 that acts on the annular face 31, and refilling of the damping chamber 28 takes place from the further hydraulic chamber 23, via the overflow conduit 30 with the throttle restriction.

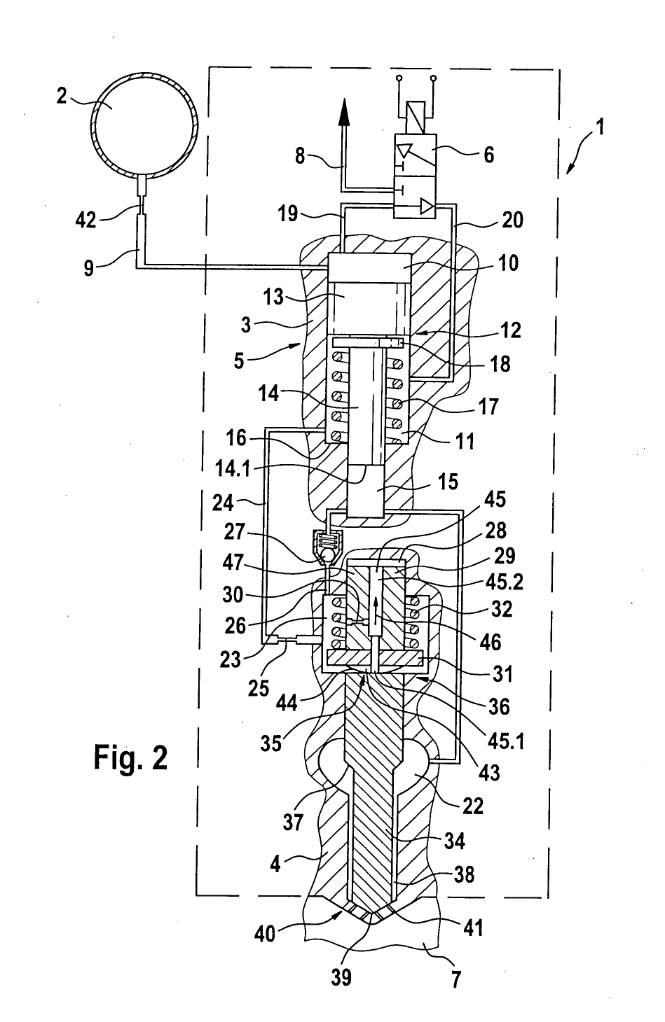

The further variant embodiment shown in FIG. 2 of the device proposed according to the invention for damping the stroke motion of the injection valve member 34 is essentially equivalent, in terms of its structure and mode of operation, to the variant embodiment of the invention described in conjunction with FIG. 1.

In a distinction from the variant embodiment of the damping element 29 shown in FIG. 1, the damping element 29 shown in FIG. 2 has a sealing face 43 on its end face oriented toward the face end 35 of the injection valve member 34. The sealing face 43 may be provided with a spherical contour 44, as shown in FIG. 2. The flow conduit 45 that penetrates the damping element 29 of FIG. 2 discharges on one end at the face end that defines the damping chamber 28 and on the other at the sealing face 43 with the spherical contour 44 below the annular face 31. The overflow conduit 45 that penetrates the damping element 29 coaxially to its line of symmetry includes a first conduit portion 45.1 and a second conduit portion 45.2. In comparison to the second, further conduit portion 45.2, the first conduit portion 45.1 is embodied with a reduced diameter, and as a result the first conduit portion 45.1 can be assigned a throttling function. Thus recoiling of the damping element 29 can be prevented.

Upon opening of the injection valve member 34 by means of a pressure buildup in the pressure chamber 22, resulting from the inflow of fuel from the compression chamber 15 into the pressure chamber 22 via the connecting line 21 and a pressure force acting on the pressure shoulder 37 of the injection valve member 34, the injection valve member 34 moves in the opening direction into the further hydraulic chamber 23. In the process, the sealing face 43 on the underside of the annular face 31 is closed. Thus the flow conduit 45.1 in the interior of the damping element 29 is closed. The fuel positively displaced out of the damping chamber 28 can flow out into the further hydraulic chamber 23 only via the second conduit portion 45.2 and the overflow line, with a throttle restriction 30, that penetrates a wall 47 of the damping element 29. In this way, the opening speed of the injection valve member 34 is limited and is dependent on the configuration of the throttle restriction, that is, its control of flow through the wall 47 of the damping element 29. Upon closure of the injection valve member 34, its face end 35 separates from the sealing face 43 on the underside of the annular face 31 of the damping element 29. As a result, the opening of the flow conduit 45.1 of the damping element 29 in the sealing face 43 is uncovered, causing fuel to flow into the damping chamber 28 via the first conduit portion 45.1 and the second conduit portion 45.2. In this way, a rapid filling of the damping chamber 28 takes place, so that the damping element 29, preferably embodied as a damping piston, returns to its outset position. In this way damping of the opening speed of the injection valve member 35 in its opening motion can be achieved, yet its fast closure is unimpaired by the device, proposed according to the invention, for damping the reciprocating motion of the injection valve member 35.

The foregoing relates to preferred exemplary embodiments of the invention, it being understood that other variants and embodiments thereof are possible within the spirit and scope of the invention, the latter being defined by the appended claims.

1-21. (canceled)

22. A device for injecting fuel into a combustion chamber (7) of an internal combustion engine, the device comprising
a fuel injector (1), which can be acted upon with fuel at high pressure via a high- pressure source (2) and is actuatable via a metering valve (6),
an injection valve member (34) surrounded by a pressure chamber (22),
the injection valve member (34) being urged in the closing direction by a closing force,
a damping element (29) associated with and movable independently of the injection valve member (34)
the damping member (29) defining a damping chamber (28) and having at least one overflow conduit (30, 45) for connecting the damping chamber (28) to a further hydraulic chamber (23).

23. The device for injecting fuel of claim 22, wherein the damping element (29) that defines the damping chamber (28) is embodied as a damping piston, which is surrounded by the further hydraulic chamber (23).

24. The device for injecting fuel of claim 22, wherein the damping element (29) and the injection valve member (34) contact one another along a dividing line (36).

25. The device for injecting fuel of claim 22, wherein the damping element (29) is prestressed via a first spring element (32), which is braced on an annular face (31) adjoining the injection valve member (34).

26. The device for injecting fuel of claim 24, further comprising a sealing face on the damping element (29) opposite a face end (35) of the injection valve member (34) is embodied as a sealing face.

27. The device for injecting fuel of claim 24, further comprising a sealing face (43) on the damping element (29) opposite a face end (35) of the injection valve member (34), the sealing face (43) having a spherical contour (44).

28. The device for injecting fuel of claim 22, wherein the damping element (29) further comprises overflow conduit (30) that includes a throttle restriction.

29. The device for injecting fuel of claim 28, wherein the overflow conduit (30) discharges into the further hydraulic chamber (23) at a side of the damping element (29) defining the damping chamber (28) and at the outer face of the damping element (29).

30. The device for injecting fuel of claim 24, wherein the damping element (29) comprises a continuous flow conduit (45), which discharges in the damping chamber (28) and at a sealing face (43) in the region of the dividing line (36).

31. The device for injecting fuel of claim 24, wherein the damping element (29) comprises a flow conduit (30) embodied in a wall (47).

32. The device for injecting fuel of claim 30, wherein the continuously extending flow conduit (45) comprises first and second conduit portions (45.1, 45.2) having different flow cross sections.

33. The device for injecting fuel of claim 32, wherein the first conduit portion (45.1) serves the continuous flow conduit (45) as a throttle restriction.

34. The device for injecting fuel of claim 22, further comprising a second spring element (33) received in the further hydraulic chamber (23) and urging the injection valve member (34) in the closing direction and pressing it into its seat (40) at the combustion chamber.

35. The device for injecting fuel of claim 22, further comprising a pressure booster (5) having a compression chamber (15) and a piston unit (12), a connecting line (21) connected between the compression chamber (15) and the pressure chamber (22) and subjecting the pressure chamber (22) to fuel that is at high pressure, the compression chamber (15), in turn, being acted upon by the piston unit (12).

36. The device for injecting fuel of claim 35, wherein the piston unit (12) includes a first partial piston (13) and a second partial piston (14) and divides a work chamber (10) and a control chamber (11), which can be made to communicate with a return (8) on the low- pressure side from one another.

37. The device for injecting fuel of claim 36, wherein a pressure change in the control chamber (11) of the pressure booster (5) causes a pressure change in a compression chamber (15).

38. The device for injecting fuel of claim 37, wherein, when the metering valve (6) is deactivated, a fluidic communication exists from the high-pressure reservoir (2) to the further hydraulic chamber (23).

39. The device for injecting fuel of claim 35, wherein, when the metering valve (6) is deactivated, a fluidic communication exists from the high-pressure reservoir (2) to the pressure chamber (22).

40. The device for injecting fuel of claim 36, further comprising a filling path (26) branching off from the further hydraulic chamber (23), wherein the compression chamber (15) can be filled via the filling path (26), and wherein the further hydraulic chamber (23) communicates with the control chamber (11) of the pressure booster (5) via an overflow line (24).

41. The device for injecting fuel of claim 40, wherein the filling path (26) to the compression chamber (15) contains a check valve (27).

42. The device for injecting fuel of claim 40, wherein the overflow line (24) between the control chamber (11) of the pressure booster (5) and the further hydraulic chamber (23) contains a throttle restriction (25).
